(19) United States
(12) Patent Application Publication
(10) Pub. No.: US 2015/0001241 A1
(43) Pub. Date: Jan. 1, 2015

(54) MODULAR VENDING MACHINE

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: CHIN-WEN YEH, New Taipei (TW); YANG XIAO, Wuhan (CN); HUI LI, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/261,637

(22) Filed: Apr. 25, 2014

(30) Foreign Application Priority Data
Jun. 27, 2013 (CN) 2013102620409

(51) Int. Cl. G07F 11/02

(52) U.S. Cl. CPC G07F 11/02
USPC 221/124

(57) ABSTRACT

A modular vending machine includes a first vending device and a second vending device for dispensing product items to customers. A mounting apparatus includes a main body mounted to a top surface of the first vending device. The second vending device is mounted to a top surface of the main body of the mounting apparatus. The numbers of the first vending device and the second vending device can be adjusted according to actual needs.

### CROSS-REFERENCE TO RELATED APPLICATIONS

This application claims priority to China Patent Application No. 201310262040.9 filed on Jun. 27, 2013 in the State Intellectual Property Office of China, the contents of which are hereby incorporated by reference.

### FIELD

The present disclosure generally relates to vending machines, and more particularly relates to modular vending machines.

### BACKGROUND

Vending machines have been in common use for vending a variety of items such as snacks, beverages, alcohol, cigarettes, lottery tickets, cologne, consumer products, and even gold and gems. A vending machine typically dispenses items to customers after the customers insert currency or credit into the vending machines. However, the conventional vending machine is inflexible and is not able to handle increasing demands.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a modular vending machine.

FIG. 2 is similar to FIG. 1, but viewed from another aspect.

FIG. 3 is an enlarged view of a circled portion III of FIG. 1.

FIG. 4 is an enlarged view of a circled portion IV of FIG. 2.

FIG. 5 is an enlarged view of a circled portion V of FIG. 1.

FIG. 6 is an enlarged view of a circled portion VI of FIG. 2.

FIG. 7 is an isometric view of a securing member of FIG. 1.

FIG. 8 is an assembled view of the modular vending machine FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

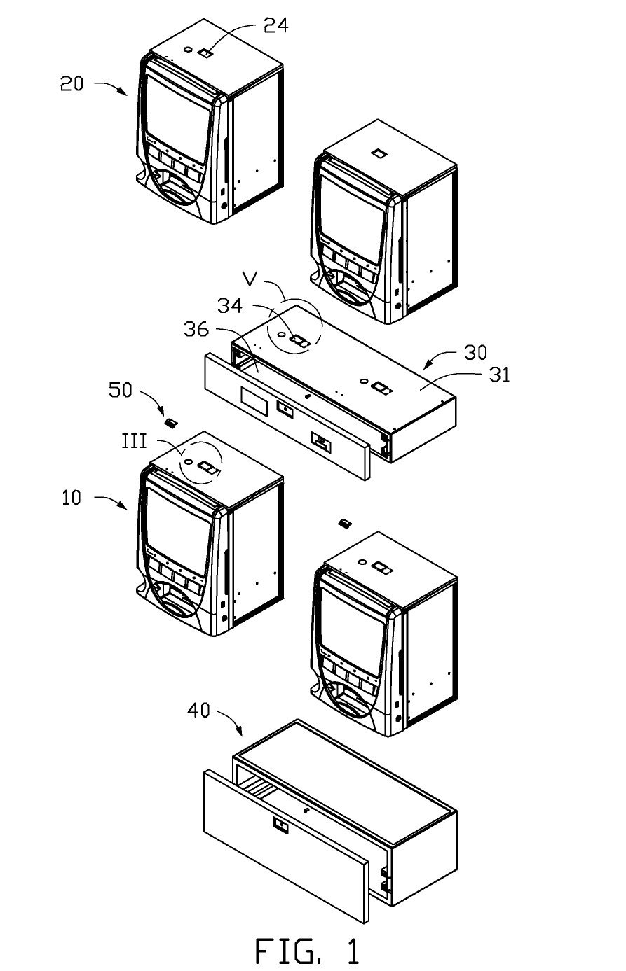

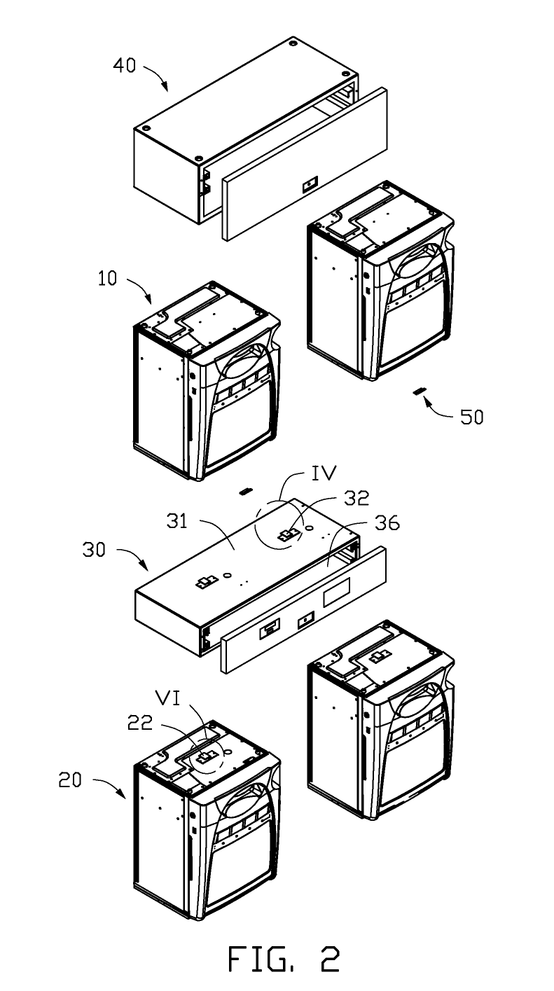

FIGS. 1 and 2 illustrate an embodiment of a modular vending machine. The modular vending machine includes at least one first vending device 10, at least one second vending device 20, at least one mounting apparatus 30, and a storage cabinet 40. Each of the first vending device 10 and the second vending device 20 is a standalone device that can dispense items to customers. The quantity of the first vending device 10 and the second vending device 20 in a given setting can be adjusted according to actual needs. In the illustrated embodiment, there are two first vending devices 10 and two second vending devices 20.

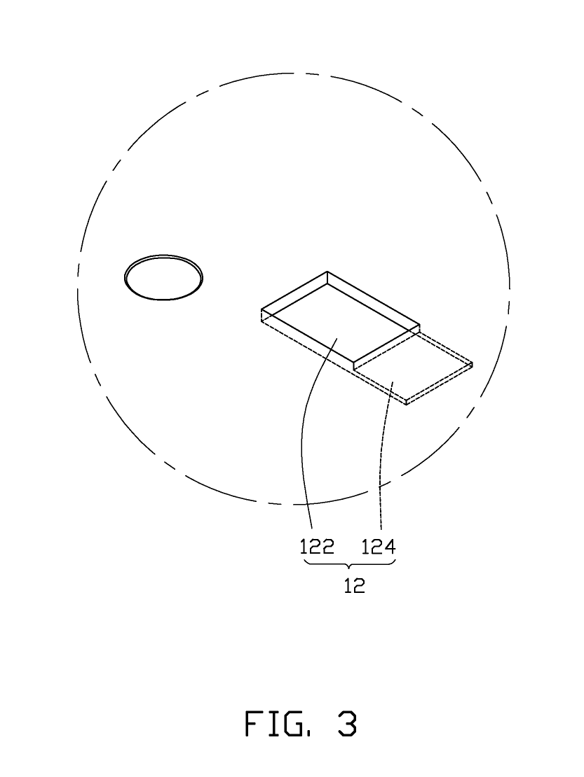

Referring to FIGS. 1 and 3, a top surface of the first vending device 10 defines a first mounting slot 12. The first mounting slot 12 includes a first guiding slot 122 and a first receiving slot 124. The first guiding slot 122 is a recess defined in the top surface of the first vending device 10. The first receiving slot 124 extends horizontally from a sidewall of the first guiding slot 122.

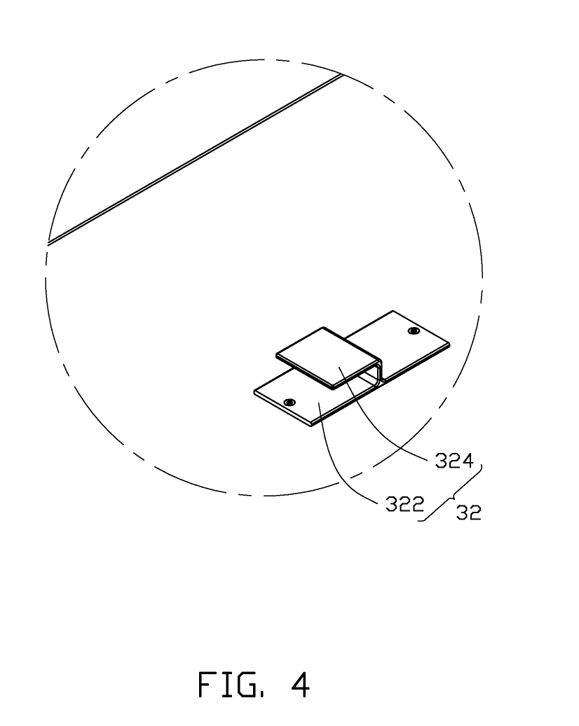

Referring to FIGS. 2 and 4, the mounting apparatus 30 includes a main body 31 and at least one first mounting member 32. In the illustrated embodiment, there are two first mounting members 32. The first mounting member 32 is located on a bottom surface of the main body 31 of the mounting apparatus 30. The first mounting member 32 includes a first mounting plate 322 and a first latching plate 324. The first mounting plate 322 is mounted to the bottom surface of the main body 31 of the mounting apparatus 30. The first latching plate 324 is connected to the first mounting plate 322. The first latching plate 324 is substantially parallel to the first mounting plate 322. The first latching plate 324 can be received into the first guiding slot 122 and moved horizontally along a bottom wall of the first guiding slot 122 to be received into the first receiving slot 124, such that the mounting apparatus 30 is mounted to the top surface of the first vending device 10.

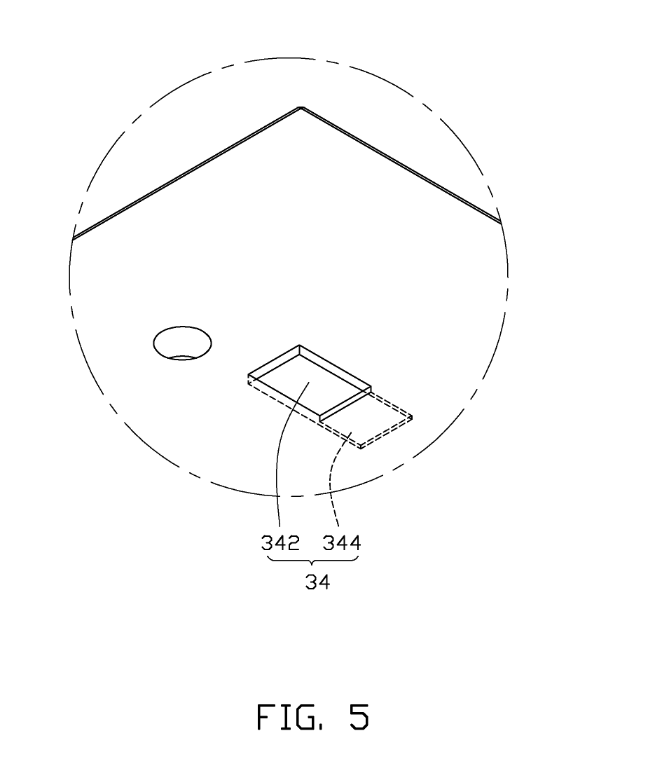

Referring to FIGS. 1 and 5, a top surface of the main body 31 of the mounting apparatus 30 defines at least one second mounting slot 34. In the illustrated embodiment, there are two second mounting slots 34. The second mounting slot 34 is substantially similar to the first mounting slot 12. The second mounting slot 34 includes a second guiding slot 342 and a second receiving slot 344. The second guiding slot 342 is a recess defined in the top surface of the main body 31 of the mounting apparatus 30. The second receiving slot 344 extends horizontally from a sidewall of the second guiding slot 342.

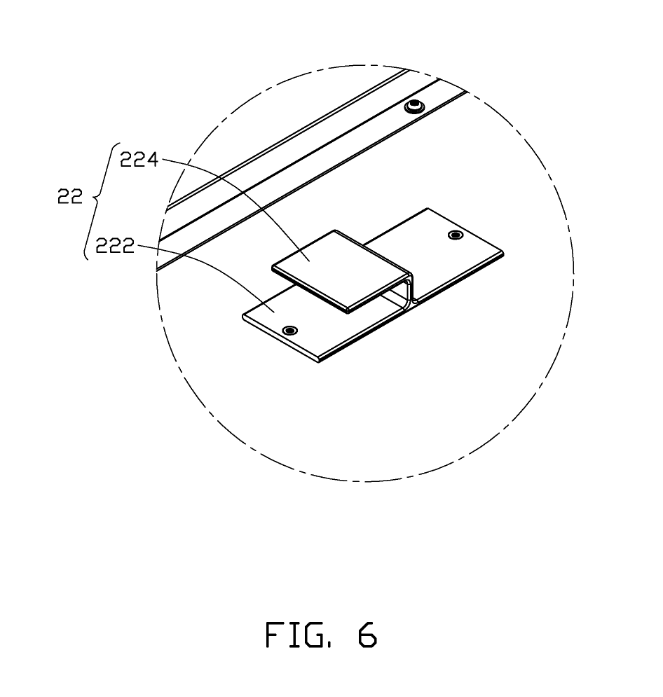

Referring to FIGS. 2 and 6, the mounting apparatus 30 includes a second mounting member 22. The second mounting member 22 is located on a bottom surface of the second vending device 20. The second mounting member 22 is substantially similar to the first mounting member 32. The second mounting member 22 includes a second mounting plate 222 and a second latching plate 224. The second mounting plate 222 is mounted to the bottom surface of the second vending device 20. The second latching plate 224 is connected to the second mounting plate 222. The second latching plate 224 is substantially parallel to the second mounting plate 222. The second latching plate 224 can be received into the second guiding slot 342 and moved horizontally along a bottom wall of the second guiding slot 342 to be received into the second receiving slot 344, such that the second vending device 20 is mounted to the top surface of the mounting apparatus 30.

Referring to FIG. 1, a top surface of the second vending device 20 defines a third mounting slot 24. The third mounting slot 24 is substantially similar to the first mounting slot 12 and the second mounting slot 34. Another vending device or mounting apparatus can be mounted to the top surface of the second vending device 20 in a substantially similar way as the mounting apparatus 30 is mounted to the top surface of the first vending device 10.

In at least one embodiment, the main body 31 of the mounting apparatus 30 defines a storage cavity 36. Control devices of the modular vending machine or product items for replenishing the first vending device 10 and the second vending device 20 can be received in the storage cavity 36 of the mounting apparatus 30.

The storage cabinet 40 can store product items for replenishing the first vending device 10 and the second vending device 20. The storage cabinet 40 can also store repair tools or replacement parts for the modular vending machine.

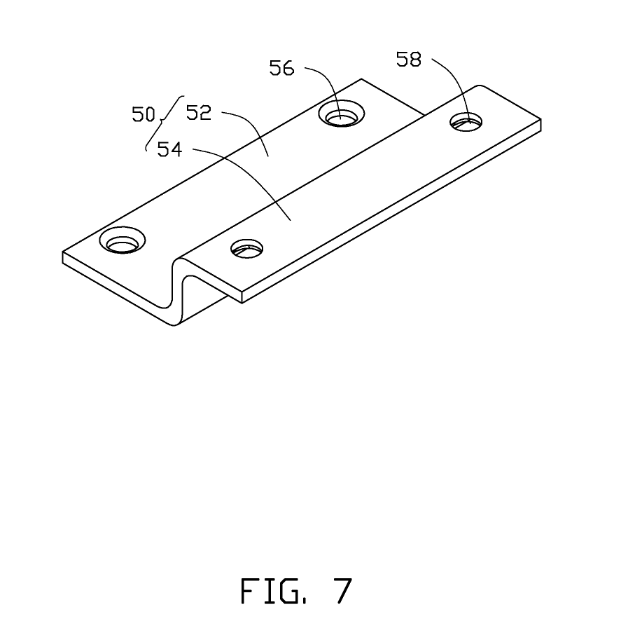

Referring to FIG. 7, the modular vending machine includes a securing member 50. A cross section of the securing member 50 is substantially Z-shaped. The securing member 50 includes a first securing plate 52 and a second securing plate 54. The second securing plate 54 is connected to the first securing plate 52. The second securing plate 54 is substantially parallel to the first securing plate 52. The first securing plate 52 defines at least one first securing hole 56, and the second securing plate 54 defines at least one second securing hole 58. In the illustrated embodiment, there are two first securing holes 56 and two second securing holes 58. The first securing plate 52 can be secured to the top surface of the first vending device 10 by a screw or other suitable securing device extending through the first securing hole 56 and a complementary hole of the first vending device 10. The second securing plate 54 can be secured to the bottom surface of the main body 31 of the mounting apparatus 30 by a screw or other suitable securing device extending through the second securing hole 58 and a complementary hole of the main body 31 of the mounting apparatus 30, such that the mounting apparatus 30 is secured to the top surface of the first vending device 10.

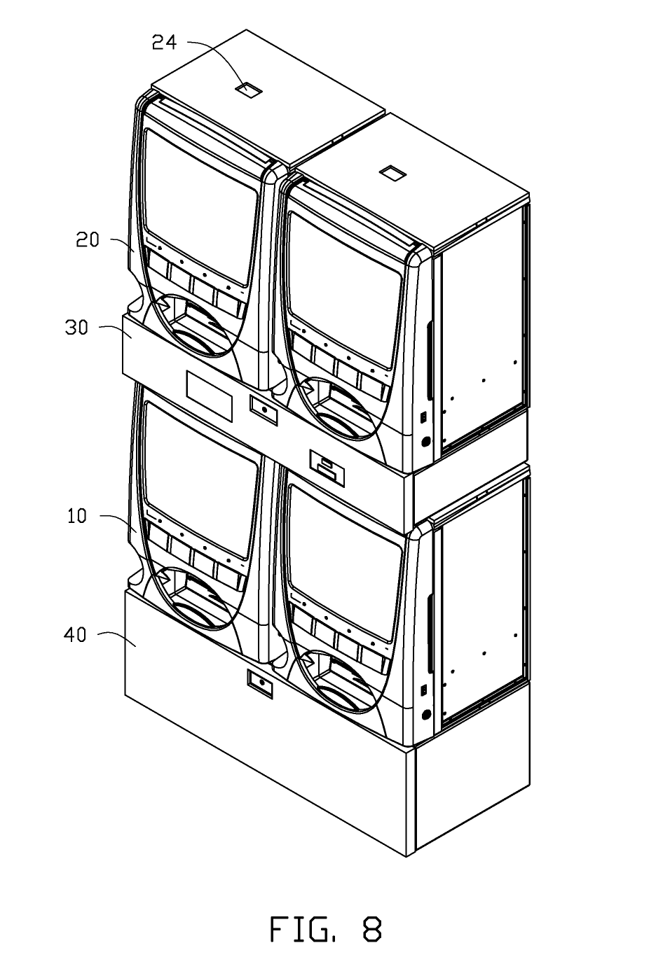

FIG. 8 illustrates an assembled state of the modular vending machine. The first vending device 10 is placed on a top surface of the storage cabinet 40, the mounting apparatus 30 is secured to the top surface of the first vending device 10, and the second vending device 20 is secured to the top surface of the mounting apparatus 30.

The first latching plate 324 of the first mounting member 32 is received into the first guiding slot 122 and moved horizontally along a bottom wall of the first guiding slot 122, until the first latching plate 324 is received into the first receiving slot 124. Thus, the mounting apparatus 30 is mounted to the top surface of the first vending device 10.

The second latching plate 224 of the second mounting member 22 is received into the second guiding slot 342 and moved horizontally along a bottom wall of the second guiding slot 342, until the second latching plate 224 is received into the second receiving slot 344. Thus, the second vending device 20 is mounted to the top surface of the mounting apparatus 30.

The first securing plate 52 of the securing member 50 is secured to the top surface of the first vending device 10 by a screw or other suitable securing device extending through the first securing hole 56 and a complementary hole of the first vending device 10. The second securing plate 54 of the securing member 50 is secured to the bottom surface of the main body 31 of the mounting apparatus 30 by a screw of other suitable securing device extending through the second securing hole 58 and a complementary hole of the main body 31 of the mounting apparatus 30. Thus, the mounting apparatus 30 is secured to the top surface of the first vending device 10.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed. The disclosed embodiments are illustrative examples, and are not intended to limit the scope of the following claims.

What is claimed is:

1. A modular vending machine, comprising:
a first vending device and a second vending device for dispensing product items to customers; and
a mounting apparatus comprising a main body mountable to a top surface of the first vending device, wherein the second vending device is mountable to a top surface of the main body of the mounting apparatus.

2. The modular vending machine of claim 1, wherein the mounting apparatus further comprises a first mounting member mounted to a bottom surface of the main body, the top surface of the first vending device defines a first mounting slot, and the first mounting member is engagable with the first mounting slot for mounting the mounting apparatus to the top surface of the first vending device.

3. The modular vending machine of claim 2, wherein the first mounting member comprises a first mounting plate mounted to the bottom surface of the main body of the mounting apparatus and a first latching plate connected to the first mounting plate, the first latching plate is receivable in the first mounting slot of the first vending device.

4. The modular vending machine of claim 3, wherein the first mounting slot comprises a first guiding slot and a first receiving slot, the first guiding slot comprises a recess defined in the top surface of the first vending device, the first receiving slot extends horizontally from a sidewall of the first guiding slot, the first latching plate is slidable along a bottom wall of the first guiding slot, and the first latching plate is receivable by the first receiving slot.

5. The modular vending machine of claim 4, wherein the first latching plate is substantially parallel to the first mounting plate.

6. The modular vending machine of claim 1, wherein the mounting apparatus further comprises a second mounting member mounted to a bottom surface of the second vending device, the top surface of the main body of the mounting apparatus defines a second mounting slot, and the second mounting member is engagable with the second mounting slot for mounting the second vending device to the top surface of main body of the mounting apparatus.

7. The modular vending machine of claim 6, wherein the second mounting member comprises a second mounting plate mounted to the bottom surface of the first vending device and a second latching plate connected to the second mounting plate, the second latching plate is receivable in the second mounting slot of the main body of the mounting apparatus.

8. The modular vending machine of claim 7, wherein the second mounting slot comprises a second guiding slot and a second receiving slot, the second guiding slot is a recess defined in the top surface of the main body of the mounting apparatus, the second receiving slot extends horizontally from a sidewall of the second guiding slot, the second latching plate is slidable along a bottom wall of the second guiding slot, and the second latching plate is received into the second receiving slot.

9. The modular vending machine of claim 8, wherein the second latching plate is substantially parallel to the second mounting plate.

10. The modular vending machine of claim 1, wherein the main body of the mounting apparatus defines a storage cavity configured to receive control devices of the modular vending machine or configured to receive product items for replenishing the first vending device and the second vending device.

11. The modular vending machine of claim 1, further comprising a securing member, wherein the securing member comprises a first securing plate and a second securing plate connected to the first securing plate, the first securing plate is secured to the top surface of the first vending device, and the second securing plate is secured to the bottom surface of the main body of the mounting apparatus.

12. The modular vending machine of claim 11, wherein a cross section of the securing member is substantially Z-shaped.

13. The modular vending machine of claim 11, wherein the second securing plate is substantially parallel to the first securing plate.

14. The modular vending machine of claim 11, wherein the first securing plate defines a first securing hole, the first securing plate is secured to the top surface of the first vending device by a securing device extending through the first securing hole and a complementary hole of the first vending device.

15. The modular vending machine of claim 11, wherein the second securing plate defines a second securing hole, the second securing plate is secured to the bottom surface of the main body of the mounting apparatus by a securing device extending through the second securing hole and a complementary hole of the main body of the mounting apparatus.

16. The modular vending machine of claim 1, further comprising a storage cabinet, wherein the first vending machine is located on a top surface of the storage cabinet.
